(19) United States
(12) Patent Application Publication
(10) Pub. No.: US 2025/0272552 A1
(43) Pub. Date: Aug. 28, 2025

(54) MACHINE LEARNING MODEL TRAINING ON RISK PREDICTION USING GRAPH KNOWLEDGE DISTILLATION

(71) Applicant: eBay Inc., San Jose, CA (US)

(72) Inventors: Zhichao Han, Shanghai (CN); Zitao Zhang, San Jose, CA (US); Bo Qu, Shanghai (CN); Yang Zhao, Shanghai (CN); Yinan Shan, Shanghai (CN); Hang Yin, San Jose, CA (US); Wenyu Dong, Shanghai (CN); Weiming Liang, Shanghai (CN)

(21) Appl. No.: 18/585,734

(22) Filed: Feb. 23, 2024

(51) Int. Cl. G06N 3/08

(52) U.S. Cl. CPC G06N 3/08

(57) ABSTRACT

Various embodiments described herein support or provide operations including identifying a machine-learning (ML) model associated with an omni-view knowledge graph; generating an embedding vector that represents the omni-view knowledge graph; identifying a ML model associated with a temporal-view knowledge graph; generating an embedding vector that represents the temporal-view knowledge graph; and training a ML model based on the generated embedding vectors.

### TECHNICAL FIELD

The present disclosure generally relates to data processing using machine learning technologies. More particularly, various embodiments described herein provide for systems, methods, techniques, instruction sequences, and devices that facilitate machine learning model training on risk prediction using graph knowledge distillation.

### BACKGROUND

Existing systems face challenges in effectively applying knowledge on past events to detect risky events online. Specifically, there is a knowledge gap between Graph Neural Networks (GNN) teacher models having an omni-view knowledge graph representing all past events and GNN student models that only see a temporal view of ongoing events. When the student models are used for online fraud prediction or risk detection, the accuracy of such prediction or detection can be impacted if the student models cannot be or have not been trained by the teacher models to learn the knowledge of past events.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of examples, and not limitations, in the accompanying figures.

FIG. 1 is a block diagram showing an example data system that includes a data management system, according to various embodiments of the present disclosure.

FIG. 2 is a block diagram illustrating an example data management system that facilitates machine learning model training on risk prediction using graph knowledge distillation, according to various embodiments of the present disclosure.

FIG. 3 is a flowchart illustrating an example method for facilitating machine learning model training on risk prediction using graph knowledge distillation, according to various embodiments of the present disclosure.

FIG. 4 is a flowchart illustrating an example method for facilitating machine learning model training on risk prediction using graph knowledge distillation, according to various embodiments of the present disclosure.

FIG. 5 is a diagram illustrating data flow within an example data management system that facilitates machine learning model training on risk prediction using graph knowledge distillation, according to various embodiments of the present disclosure.

FIG. 6 is diagrams illustrating distribution graphs representing embedding vectors and prediction outputs generated by methods for facilitating machine learning model training on risk prediction using graph knowledge distillation, according to various embodiments of the present disclosure.

FIG. 7 is a block diagram illustrating a representative software architecture, which may be used in conjunction with various hardware architectures herein described, according to various embodiments of the present disclosure.

FIG. 8 is a block diagram illustrating components of a machine able to read instructions from a machine storage medium and perform any one or more of the methodologies discussed herein according to various embodiments of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various embodiments may be given throughout this description. These are merely descriptions of specific embodiments. The scope or meaning of the claims is not limited to the embodiments given.

Existing systems face challenges in effectively applying knowledge of past transaction events to detect online risky transaction events. Specifically, there is a knowledge gap between Graph Neural Networks (GNN) teacher models with an omni-view knowledge graph representing all past transaction events and GNN student models with a temporal view of ongoing transaction events. Traditional GNN models can only handle post-analysis scenarios where experience and patterns on risk and fraud detection can be learned after the fact and thereby cannot be applied directly to prediction for ongoing transactions online. For example, in a neural network graph described herein, a GNN model cannot accurately predict whether a node representing a transaction is legitimate or fraudulent without having one or more neighbor nodes claiming a chargeback. Therefore, when a student model is used for online fraud prediction or risk detection, the accuracy of such prediction or detection can be impacted if the student models cannot be or have not been trained by teacher models to learn the knowledge, experience and/or patterns of the past transaction events.

Various embodiments include systems, methods, and non-transitory computer-readable media that facilitate machine learning model training on risk prediction using graph knowledge distillation, according to various embodiments of the present disclosure. Specifically, the present disclosure involves training machine-learning models for optimized performance on online fraud prediction and/or transaction risk detection. Knowledge distillation is used for model training where a GNN student machine learning model that only learns knowledge of ongoing transaction events can be trained based on knowledge of past transaction events learned by one or more GNN teacher machine learning models. After the training, the GNN student machine learning model is capable of making more accurate fraud predictions and detection of risky transactions as if it possesses the knowledge, experience, and patterns of risky and fraudulent transactions learned the one or more GNN teacher machine learning models based on all past transaction events.

In some examples, past transaction events can be associated with transactions that are completed (e.g., item delivered, and/or payment processed). Ongoing transaction events can be associated with transactions that are pending. (e.g., item to be shipped or delivered, and/or payment to be processed). In some examples, the data management system (or an administrative user of the data management system) can define and/or update the criteria used to qualify a transaction as being completed or pending.

In some examples, a temporal-view knowledge graph includes nodes and edges representing transaction events associated with ongoing transactions happening at the moment (e.g., item to be shipped or delivered, and/or payment to be processed). In contrast, an omni-view knowledge graph includes nodes and edges representing transactions associated with complete transactions (e.g., item delivered, and/or payment processed). The representation of the complete transactions includes all relevant transaction events that occurred across various times and spaces. In some examples, the knowledge graph includes graph structures that indicate relationships between user nodes and item notes, connected by edges representing timestamps. Knowledge of fraudulent transactions can be learned based on the relationships between nodes. For example, if a risky user node (or a risky item node) claims a chargeback on (or connects to) a neighbor node, the transaction or transaction event associated with the neighbor node can also be determined as “risky.”

In some examples, a data management system can identify a machine-learning (ML) model (e.g., the first ML model) associated with an omni-view knowledge graph. The first ML model can be a Graph Neural Network (GNN) teacher ML model. An omni-view graph can be a holistic static neural network graph that includes a plurality of nodes representing a plurality of past transaction events. In an example graph, a node can either represent a user or an item. In this example, an edge that connects a user node and an item node can represent a timestamp. In this example, an item node can represent an IP address, a shipping address, a telephone number, etc. A transaction can be associated with one or more transaction events occurring at different timestamps.

In some examples, an omni-view graph can be updated periodically to ensure that the graph reflects the latest view of all available past transaction events available to the system. Analysis (also referred to as post-analysis) can be performed on an omni-view graph to distill the knowledge and experience on risky and/or fraudulent transactions, including learned patterns of such risky and/or fraudulent transactions.

In some examples, the data management system can use the GNN teacher model (also referred to as a GNN teacher ML model) to generate an embedding vector (e.g., the first embedding vector) that represents the omni-view knowledge graph (or a segment of the graph). An embedding vector (also referred to as an embedding) can include data in a computationally digestible format usable by one or more machine learning models. In some examples, an embedding can include a vector representing relevant information of a specific neural network graph, including the nodes, edges, and the structure of the graph.

In some examples, the data management system can identify a GNN student ML model (e.g., the second ML model) associated with a temporal-view knowledge graph representing a plurality of ongoing transaction events. The GNN student ML model is also referred to as the GNN student model or student model described herein. The GNN student model can be used to detect and predict risky and fraudulent transactions online.

In some examples, the data management system can use the second ML model to generate another embedding vector (e.g., the second embedding vector) that represents the temporal-view knowledge graph. In some examples, the second ML model can be a GNN student ML model.

In some examples, the data management system can train the GNN student ML model to learn the omni-view knowledge graph based on the first embedding vector and the second embedding vector described herein.

In some examples, the data management system can apply a loss function (e.g., the first loss function) to the first embedding vector that represents the omni-view knowledge graph and the second embedding vector that represents the temporal-view knowledge graph. A loss (represented by a value) can be generated in response to applying the first loss function. In some examples, the first loss function can be a Normalized Temperature-scaled Cross Entropy Loss (NTXent) loss function.

In some examples, the data management system can use a decoder to generate a prediction output value of an ongoing transaction event based on the embedding vector (e.g., the second embedding vector) that represents the temporal-view knowledge graph. In some examples, the decoder can be (or correspond to) a logistic regression ML model or a multilayer neural network ML model. A decoder can translate embedding vectors into data in specific formats that can be read and processed for downstream analysis.

In some examples, the data management system can apply a different loss function (e.g., the second loss function) to the prediction output value of the ongoing transaction events to generate a loss (e.g., the second loss, represented by a value). In some examples, the second loss function can be a Binary Cross Entropy (BCE) loss function.

In some examples, the data management system can adjust various model parameters (or features) of the GNN student ML model based on a sum value of the first loss and the second loss, for purposes of model training. During the training process, upon determining that the sum value of the first loss and the second loss is below a threshold value (or within a controlled numerical range), the data management system can conclude the training process of the GNN student ML model.

In some examples, the data management system can identify a batch (also referred to as an epoch or a training epoch) of data based on a graph described herein. An example graph (e.g., omni-view graph or temporal view graph) can include transaction events associated with any number of users (e.g., hundreds to millions of users). A batch (or epoch) includes a segment (or a subset) of the data set of a graph. A batch, or a training epoch, of data, can include a number of transaction events associated with one or more hundreds of users, for example. The data management system can perform the described operations for each batch of data and compare the sum values of loss associated with each batch. The data management system (or an administrative user of the data management system) can tune (or adjust) the parameters of a GNN student model during training based on the sum values of loss generated for each batch. In some examples, upon determining that the sum values of loss have become stabilized (e.g., falling within a permitted numerical range), indicating that the GNN student model is capable of making predictions similar to a GNN teacher model, the data management system can conclude the training process of the GNN student ML model. The trained GNN student ML model can be used for online fraud prediction and/or risk detection with optimized performance capabilities.

In some examples, stochastic gradient descent learning algorithms can be used for model training described herein. In some examples, stochastic gradient descent (SGD) is a type of gradient descent learning algorithm that runs a training epoch for each example within the dataset and updates each training example's parameters one at a time. Gradient descent is an optimization algorithm to train machine learning models and neural networks. Training data helps ML models learn over time, and the loss function within gradient descent specifically acts as a barometer, gauging its accuracy with each iteration of parameter updates. Until the loss function is close to or equal to zero, the ML model can adjust its parameters to yield the smallest possible error.

Reference will now be made in detail to embodiments of the present disclosure, examples of which are illustrated in the appended drawings. The present disclosure may, however, be embodied in many different forms and should not be construed as being limited to the embodiments set forth herein.

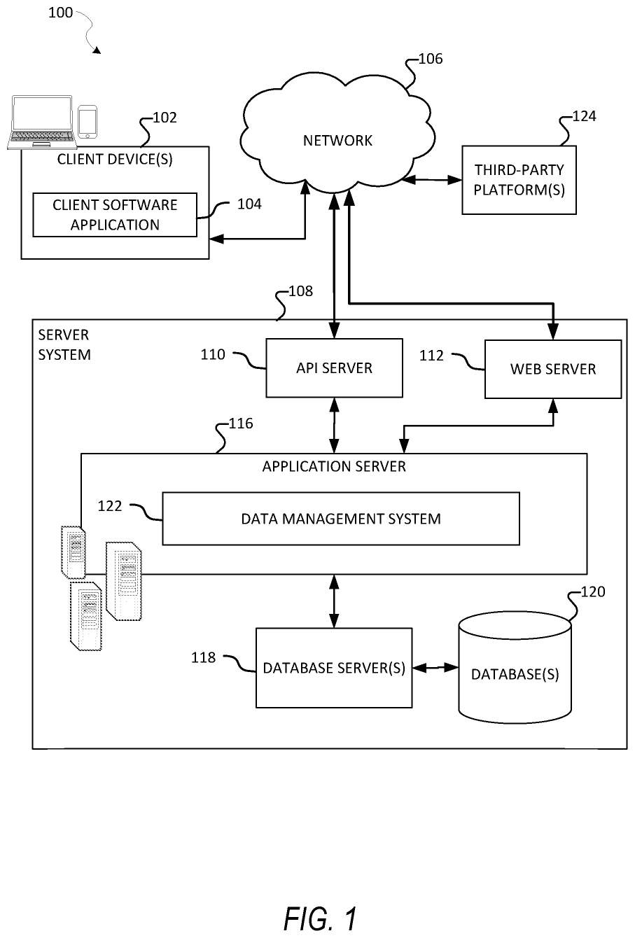

FIG. 1 is a block diagram showing an example data system 100 that includes a data management system 122 (also referred to as system 122), according to various embodiments of the present disclosure. By including the data management system 122, the data system 100 can facilitate machine learning model training on risk prediction using graph knowledge distillation. As shown, the data system 100 includes one or more client devices 102, a server system 108, and a network 106 (e.g., Internet, wide-area-network (WAN), local-area-network (LAN), wireless network) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the data system 100 are described herein as being performed by the data management system 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104.

The server system 108 supports various services and operations that are provided to the client software application 104 by the data management system 122. Such operations include transmitting data from the data management system 122 to the client software application 104, receiving data from the client software application 104 at the data management system 122, and the data management system 122 processing data generated by the client software application 104. Data exchanges within the data system 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, an Application Program Interface (API) server 110 and a web server 112 is coupled to an application server 116, which hosts the data management system 122. The application server 116 is communicatively coupled to a database server 118, which facilitates access to a database 120 that stores data associated with the application server 116, including data that may be generated or used by the data management system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation, user registration; login functionality; data object operations (e.g., generating, storing, retrieving, encrypting, decrypting, transferring, access rights, licensing); and/or user communications.

The server system 108, or the data management system 122 may extract user data from one or more third-party platforms (e.g., third-party social media platforms). The extracted data may be open-source poster data associated with targeted influencers on the one or more third-party platforms 124 and may include user profile data, activity data, and media posted (either created and/or shared) by the one or more influencers. The media (or media data) include text, image, video, audio, and metadata. Example metadata may include hashtags and labels.

Through one or more web-based interfaces (e.g., web-based user interfaces), the web server 112 can support various functionality of the data management system 122 of the application server 116.

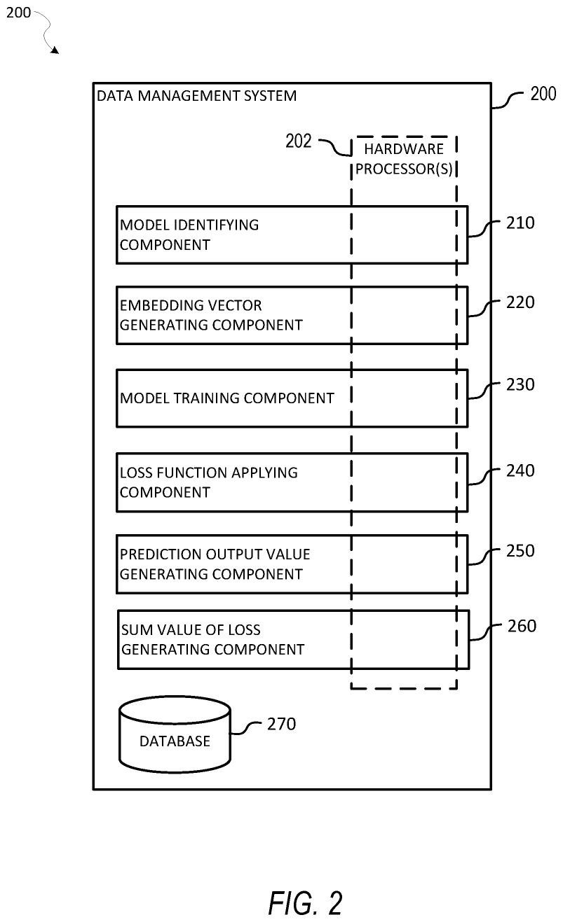

FIG. 2 is a block diagram illustrating an example data management system 200 that facilitates machine learning model training on risk prediction using graph knowledge distillation, according to various embodiments of the present disclosure. For some embodiments, the data management system 200 represents an example of the data management system 122 described with respect to FIG. 1. As shown, the data management system 200 comprises a model identifying component 210, an embedding vector generating component 220, a model training component 230, a loss function applying component 240, a prediction output value generating component 250, and a sum value of loss generating component 260. According to various embodiments, one or more of the model identifying component 210, the embedding vector generating component 220, the model training component 230, the loss function applying component 240, the prediction output value generating component 250, and the sum value of loss generating component 260 are implemented by one or more hardware processors 202. Data generated by one or more of the model identifying component 210, the embedding vector generating component 220, the model training component 230, the loss function applying component 240, the prediction output value generating component 250, and the sum value of loss generating component 260 may be stored in a database (or datastore) 270 of the data management system 200.

The model identifying component 210 is configured to identify a machine-learning (ML) model (e.g., the first ML model) associated with an omni-view knowledge graph representing a plurality of past transaction events. The first ML model can be a Graph Neural Network (GNN) teacher ML model. The model identifying component 210 is also configured to identify a GNN student ML model (e.g., the second ML model) associated with a temporal-view knowledge graph representing a plurality of ongoing transaction events.

The embedding vector generating component 220 is configured to generate an embedding vector (e.g., the first embedding vector, the second embedding vector) that represents a graph (e.g., the omni-view knowledge graph, the temporal-view knowledge graph).

The model training component 230 is configured to train a GNN student ML model to learn the omni-view knowledge graph based on an embedding vector generated based on the omni-view knowledge graph and an embedding vector generated based on the temporal-view knowledge graph. In some examples, the model training can include the application of loss functions, generation of prediction output values, and generation of sum values of loss performed by the loss function applying component 240, the prediction output value generating component 250, and the sum value of loss generating component 260 respectively. Therefore, the model training component 230 can optionally include the loss function applying component 240, the prediction output value generating component 250, and the sum value of loss generating component 260.

The loss function applying component 240 is configured to apply a loss function (e.g., the first loss function) to the first embedding vector that represents the omni-view knowledge graph and the second embedding vector that represents the temporal-view knowledge graph. The loss function applying component 240 is further configured to apply a loss function (e.g., the second loss function) to the prediction output value of the ongoing transaction events to generate a loss (e.g., the second loss, represented by a value).

The prediction output value generating component 250 is configured to use a decoder to generate a prediction output value of an ongoing transaction event based on the embedding vector (e.g., the second embedding vector) that represents the temporal-view knowledge graph. In some examples, the decoder can be (or correspond to) a logistic regression ML model or a multilayer neural network ML model.

The sum value of loss generating component 260 is configured to generate a sum value based on the first loss and the second loss described herein.

In some examples, the model training component 230 is further configured to conclude a training process of a GNN student ML model upon determining that the sum value of the first loss and the second loss is below a threshold value (or within a controlled numerical range).

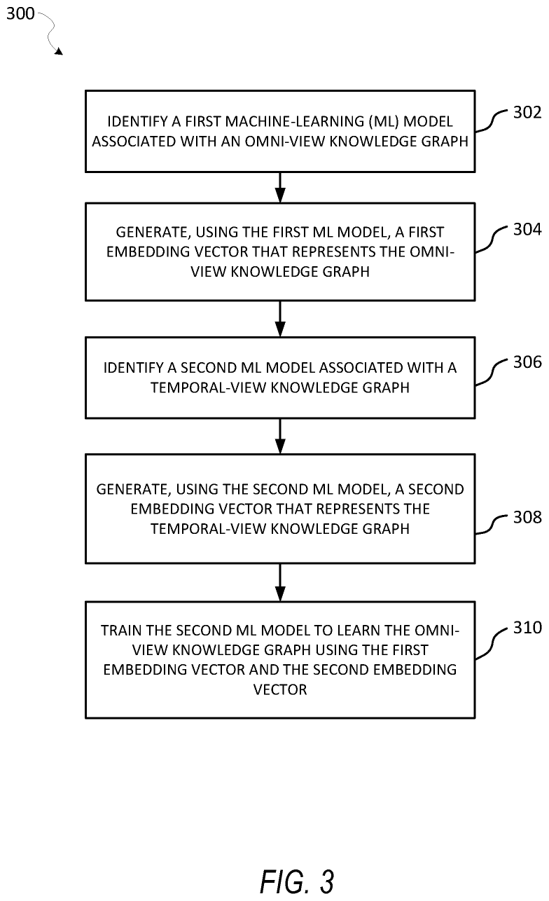

FIG. 3 is a flowchart illustrating an example method 300 for facilitating machine learning model training on risk prediction using graph knowledge distillation, according to various embodiments of the present disclosure. It will be understood that example methods described herein may be performed by a machine in accordance with some embodiments. For example, method 300 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 300 may be represented by executable instructions that, when executed by a processor of a computing device, cause the computing device to perform method 300. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 302, a processor identifies a machine-learning (ML) model (e.g., the first ML model) associated with an omni-view knowledge graph representing a plurality of past transaction events. The first ML model can be a Graph Neural Network (GNN) teacher ML model.

At operation 304, a processor generates, using a GNN teacher model, an embedding vector (e.g., the first embedding vector) that represents an omni-view knowledge graph (or a segment of the graph).

At operation 306, a processor identifies a GNN student ML model (e.g., the second ML model) associated with a temporal-view knowledge graph representing a plurality of ongoing transaction events.

At operation 308, a processor generates, using a GNN student ML model, an embedding vector (e.g., the second embedding vector) that represents a temporal-view knowledge graph.

At operation 310, a processor trains the GNN student ML model to learn the omni-view knowledge graph based on the first embedding vector and the second embedding vector described herein.

Though not illustrated, method 300 can include an operation where a graphical user interface is displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 302 through 310 or, alternatively, form part of one or more of operations 302 through 310.

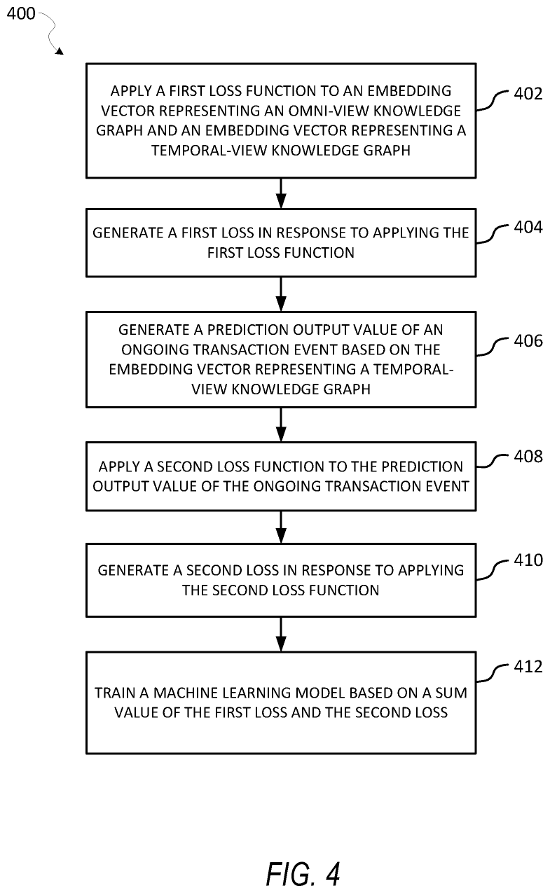

FIG. 4 is a flowchart illustrating an example method 400 for facilitating machine learning model training on risk prediction using graph knowledge distillation, according to various embodiments of the present disclosure. It will be understood that example methods described herein may be performed by a machine in accordance with some embodiments. For example, method 400 can be performed by the data management system 122 described with respect to FIG. 1, the data management system 200 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture.

Example methods described herein may also be implemented in the form of executable instructions stored on a machine-readable medium or in the form of electronic circuitry. For instance, the operations of method 400 may be represented by executable instructions that, when executed by a processor of a computing device, cause the computing device to perform method 400. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 400 can be performed dependently or independently from operations in method 300.

At operation 402, a processor applies a loss function (e.g., the first loss function) to the first embedding vector that represents the omni-view knowledge graph.

At operation 404, a processor generates a loss (represented by a value) in response to applying the first loss function. In some examples, the first loss function can be a Normalized Temperature-scaled Cross Entropy Loss (NTXent) loss function.

At operation 406, a processor generates, using a decoder, a prediction output value of an ongoing transaction event based on an embedding vector (e.g., the second embedding vector) that represents the temporal-view knowledge graph. In some examples, the decoder can be (or correspond to) a logistic regression ML model or a multilayer neural network ML model.

At operation 408, a processor applies a different loss function (e.g., the second loss function) to the prediction output value of the ongoing transaction events to generate a loss (e.g., the second loss, represented by a value). In some examples, the second loss function can be a Binary Cross Entropy (BCE) loss function.

At operation 410, a processor generates a loss (represented by a value) in response to applying the second loss function.

At operation 412, a processor trains a GNN student model based on a sum value of the first loss and the second loss described herein. For example, a processor can adjust various model parameters (or features) of the GNN student ML model during the training process. Upon determining that the sum value of the first loss and the second loss is below a threshold value (or within a controlled numerical range), the training process of the GNN student ML model can be concluded.

Though not illustrated, method 400 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 402 through 412 or, alternatively, form part of one or more of operations 402 through 412.

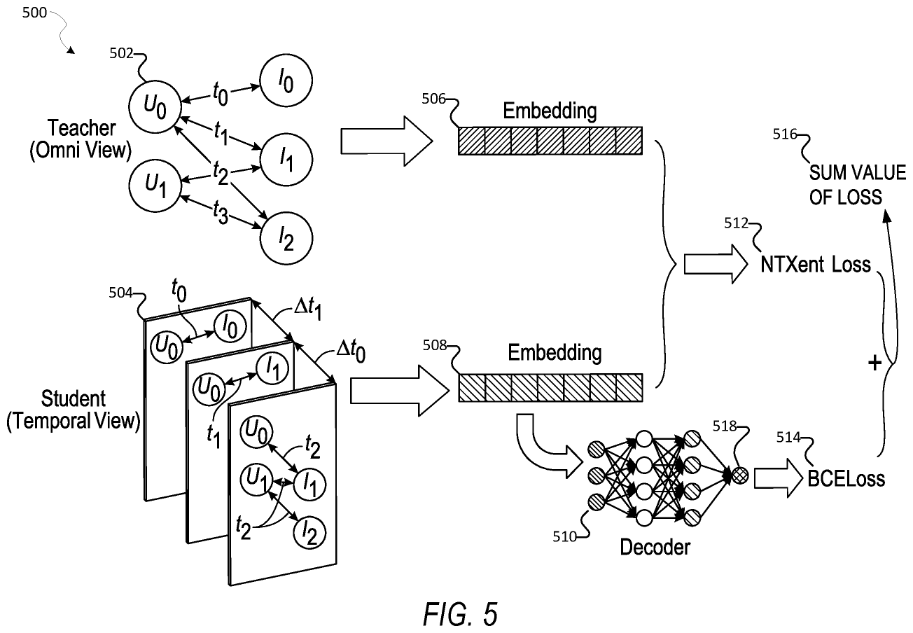

FIG. 5 is a diagram illustrating data flow 500 within an example data management system that facilitates machine learning model training on risk prediction using graph knowledge distillation, according to various embodiments of the present disclosure. As shown, graph 502 is an example omni-view knowledge graph having a plurality of nodes. U0 and U1 represent user nodes. I0, I1, and I2 represent item nodes. T0, T1, T2, and T3 represent edges. An edge can represent a timestamp associated with a transaction event. Item nodes I0, I1, and I2 can represent a transaction item, such as an IP address, a shipping address, a telephone number, etc.

As shown, graph 504 is an example temporal-view knowledge graph that includes nodes and edges representing transaction events that have already happened and are happening at the moment. A temporal-view knowledge graph does not include transaction events that will happen in the future. Under the knowledge distillation approach described herein, a GNN student model having a temporal-view knowledge graph can be trained to generate embeddings similar to the embeddings generated by a GNN teacher model so that the GNN student model's capability of determining risks and fraud probability of a given transaction is improved as if it possesses the knowledge of the teacher model.

As shown, embedding 506 represents an embedding vector generated based on graph 502. Embedding 508 represents an embedding vector generated based on graph 504. Decoder 510 can be (or correspond to) a logistic regression ML model or a multilayer neural network ML model. Prediction output value 518 can be used as an input value to a loss function 514 (e.g., Binary Cross Entropy (BCE) loss function) to generate a loss (e.g., the second loss) described herein. Loss function 512 can generate a loss (e.g., the first loss) based on embedding 506 and embedding 508. Sum value of loss 516 can be used to at least determine whether a training process for a GNN student model associated with graph 504 can be concluded.

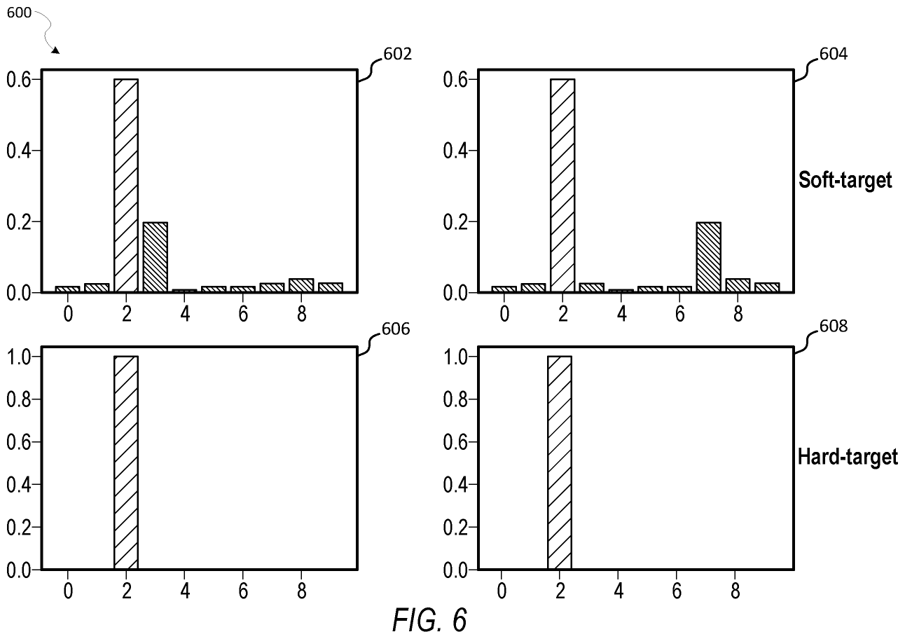

FIG. 6 is diagrams illustrating distribution graphs representing embedding vectors and prediction outputs generated by methods for facilitating machine learning model training on risk prediction using graph knowledge distillation, according to various embodiments of the present disclosure. As shown, graph 602 represents embedding 506, illustrated in FIG. 5. Graph 604 represents embedding 508, illustrated in FIG. 5. During the training process described herein, the distribution of graph 604 can be further improved to look similar to the distribution in graph 602. Improvements on similarity between graph 602 and graph 604 indicate an improved performance capability of the GNN student model making predictions similar to a GNN teacher model.

As shown, graph 606 represents prediction output value 518, as illustrated in FIG. 5. Graph 608 represents a prediction output value generated by a GNN teacher model associated with omni-view knowledge graph 502, as illustrated in FIG. 5. Even though graph 602 and graph 604 are not identical, the corresponding prediction output values can still be close enough to be considered the same (i.e., 2), as illustrated in FIG. 6.

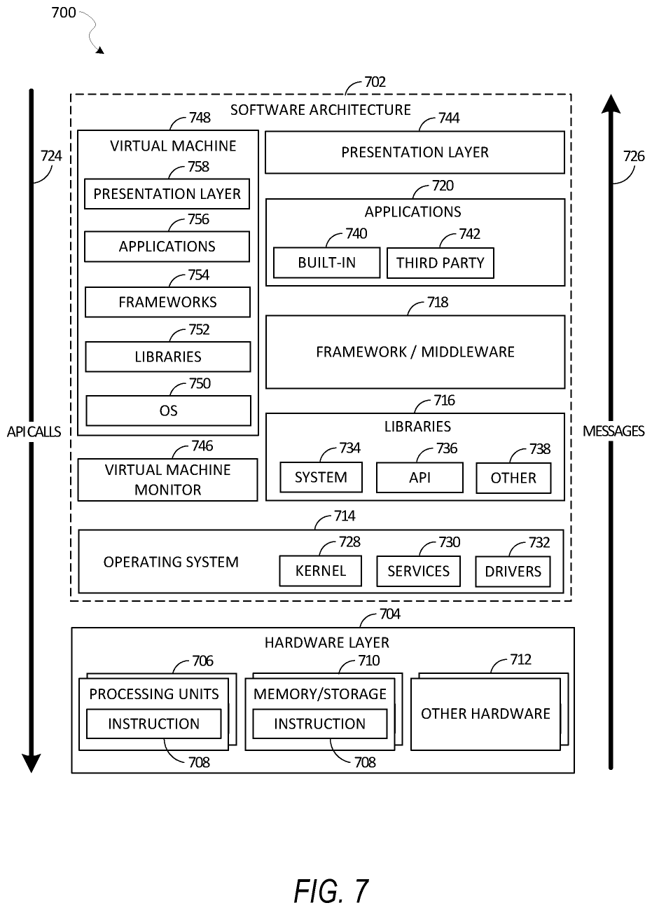

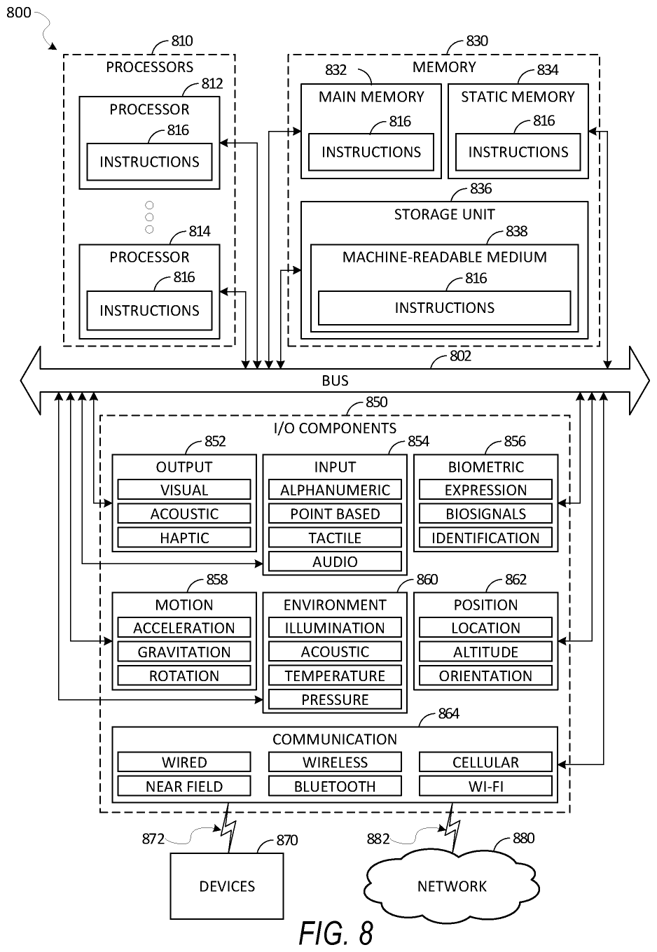

FIG. 7 is a block diagram illustrating an example of a software architecture 702 that may be installed on a machine, according to some example embodiments. FIG. 7 is merely a non-limiting example of a software architecture, and it will be appreciated that many other architectures may be implemented to facilitate the functionality described herein. The software architecture 702 may be executing on hardware such as a machine 800 of FIG. 8 that includes, among other things, processors 810, memory 830, and input/output (I/O) components 850. A representative hardware layer 704 is illustrated and can represent, for example, the machine 800 of FIG. 8. The representative hardware layer 704 comprises one or more processing units 706 having associated executable instructions 708. The executable instructions 708 represent the executable instructions of the software architecture 702. The hardware layer 704 also includes memory or storage modules 710, which also have the executable instructions 708. The hardware layer 704 may also comprise other hardware 712, which represents any other hardware of the hardware layer 704, such as the other hardware illustrated as part of the machine 800.

In the example architecture of FIG. 7, the software architecture 702 may be conceptualized as a stack of layers, where each layer provides particular functionality. For example, the software architecture 702 may include layers such as an operating system 714, libraries 716, frameworks/middleware 718, applications 720, and a presentation layer 744. Operationally, the applications 720 or other components within the layers may invoke API calls 724 through the software stack and receive a response, returned values, and so forth (illustrated as messages 726) in response to the API calls 724. The layers illustrated are representative in nature, and not all software architectures have all layers. For example, some mobile or special-purpose operating systems may not provide a frameworks/middleware 718 layer, while others may provide such a layer. Other software architectures may include additional or different layers.

The operating system 714 may manage hardware resources and provide common services. The operating system 714 may include, for example, a kernel 728, services 730, and drivers 732. The kernel 728 may act as an abstraction layer between the hardware and the other software layers. For example, the kernel 728 may be responsible for memory management, processor management (e.g., scheduling), component management, networking, security settings, and so on. The services 730 may provide other common services for the other software layers. The drivers 732 may be responsible for controlling or interfacing with the underlying hardware. For instance, the drivers 732 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 716 may provide a common infrastructure that may be utilized by the applications 720 and/or other components and/or layers. The libraries 716 typically provide functionality that allows other software modules to perform tasks in an easier fashion than by interfacing directly with the underlying operating system 714 functionality (e.g., kernel 728, services 730, or drivers 732). The libraries 716 may include system libraries 734 (e.g., C standard library) that may provide functions such as memory allocation functions, string manipulation functions, mathematic functions, and the like. In addition, the libraries 716 may include API libraries 736 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 716 may also include a wide variety of other libraries 738 to provide many other APIs to the applications 720 and other software components/modules.

The frameworks 718 (also sometimes referred to as middleware) may provide a higher-level common infrastructure that may be utilized by the applications 720 or other software components/modules. For example, the frameworks 718 may provide various graphical user interface functions, high-level resource management, high-level location services, and so forth. The frameworks 718 may provide a broad spectrum of other APIs that may be utilized by the applications 720 and/or other software components/modules, some of which may be specific to a particular operating system or platform.

The applications 720 include built-in applications 740 and/or third-party applications 742. Examples of representative built-in applications 740 may include, but are not limited to, a home application, a contacts application, a browser application, a book reader application, a location application, a media application, a messaging application, or a game application.

The third-party applications 742 may include any of the built-in applications 740, as well as a broad assortment of other applications. In a specific example, the third-party applications 742 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 742 may invoke the API calls 724 provided by the mobile operating system such as the operating system 714 to facilitate functionality described herein.

The applications 720 may utilize built-in operating system functions (e.g., kernel 728, services 730, or drivers 732), libraries (e.g., system libraries 734, API libraries 736, and other libraries 738), or frameworks/middleware 718 to create user interfaces to interact with users of the system. Alternatively, or additionally, in some systems, interactions with a user may occur through a presentation layer, such as the presentation layer 744. In these systems, the application/module “logic” can be separated from the aspects of the application/module that interact with the user.

Some software architectures utilize virtual machines. In the example of FIG. 7, this is illustrated by a virtual machine 748. The virtual machine 748 creates a software environment where applications/modules can execute as if they were executing on a hardware machine (e.g., the machine 800 of FIG. 8). The virtual machine 748 is hosted by a host operating system (e.g., the operating system 714) and typically, although not always, has a virtual machine monitor 746, which manages the operation of the virtual machine 748 as well as the interface with the host operating system (e.g., the operating system 714). A software architecture executes within the virtual machine 748, such as an operating system 750, libraries 752, frameworks 754, applications 756, or a presentation layer 758. These layers of software architecture executing within the virtual machine 748 can be the same as corresponding layers previously described or may be different.

FIG. 8 illustrates a diagrammatic representation of a machine 800 in the form of a computer system within which a set of instructions may be executed for causing the machine 800 to perform any one or more of the methodologies discussed herein, according to an embodiment. Specifically, FIG. 8 shows a diagrammatic representation of the machine 800 in the example form of a computer system, within which instructions 816 (e.g., software, a program, an application, an applet, an app, or other executable code) for causing the machine 800 to perform any one or more of the methodologies discussed herein may be executed. For example, the instructions 816 may cause the machine 800 to execute the method 300 described above with respect to FIG. 3 and the method 400 described above with respect to FIG. 4. The instructions 816 transform the general, non-programmed machine 800 into a particular machine 800 programmed to carry out the described and illustrated functions in the manner described. In alternative embodiments, the machine 800 operates as a standalone device or may be coupled (e.g., networked) to other machines. In a networked deployment, the machine 800 may operate in the capacity of a server machine or a client machine in a server-client network environment, or as a peer machine in a peer-to-peer (or distributed) network environment. The machine 800 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 816, sequentially or otherwise, that specify actions to be taken by the machine 800. Further, while only a single machine 800 is illustrated, the term “machine” shall also be taken to include a collection of machines 800 that individually or jointly execute the instructions 816 to perform any one or more of the methodologies discussed herein.

The machine 800 may include processors 810, memory 830, and I/O components 850, which may be configured to communicate with each other such as via a bus 802. In an embodiment, the processors 810 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 812 and a processor 814 that may execute the instructions 816. The term “processor” is intended to include multi-core processors that may comprise two or more independent processors (sometimes referred to as “cores”) that may execute instructions contemporaneously. Although FIG. 8 shows multiple processors 810, the machine 800 may include a single processor with a single core, a single processor with multiple cores (e.g., a multi-core processor), multiple processors with a single core, multiple processors with multiples cores, or any combination thereof.

The memory 830 may include a main memory 832, a static memory 834, and a storage unit 836 including machine-readable medium 838, each accessible to the processors 810 such as via the bus 802. The main memory 832, the static memory 834, and the storage unit 836 store the instructions 816 embodying any one or more of the methodologies or functions described herein. The instructions 816 may also reside, completely or partially, within the main memory 832, within the static memory 834, within the storage unit 836, within at least one of the processors 810 (e.g., within the processor's cache memory), or any suitable combination thereof, during execution thereof by the machine 800.

The I/O components 850 may include a wide variety of components to receive input, provide output, produce output, transmit information, exchange information, capture measurements, and so on. The specific I/O components 850 that are included in a particular machine will depend on the type of machine. For example, portable machines such as mobile phones will likely include a touch input device or other such input mechanisms, while a headless server machine will likely not include such a touch input device. It will be appreciated that the I/O components 850 may include many other components that are not shown in FIG. 8. The I/O components 850 are grouped according to functionality merely for simplifying the following discussion, and the grouping is in no way limiting. In some examples, the I/O components 850 may include output components 852 and input components 854. The output components 852 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 854 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 850 may include biometric components 856, motion components 858, environmental components 860, or position components 862, among a wide array of other components. The motion components 858 may include acceleration sensor components (e.g., accelerometer), gravitation sensor components, rotation sensor components (e.g., gyroscope), and so forth. The environmental components 860 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 862 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 850 may include communication components 864 operable to couple the machine 800 to a network 880 or devices 870 via a coupling 882 and a coupling 872, respectively. For example, the communication components 864 may include a network interface component or another suitable device to interface with the network 880. In further examples, the communication components 864 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 870 may be another machine or any of a wide variety of peripheral devices (e.g., a peripheral device coupled via a USB).

Moreover, the communication components 864 may detect identifiers or include components operable to detect identifiers. For example, the communication components 864 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 864, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In some examples, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 800 including processors 810), with these operations being accessible via a network (e.g., the Internet) and via one or more appropriate interfaces (e.g., an API). In certain embodiments, for example, a client device may relay or operate in communication with cloud computing systems and may access circuit design information in a cloud environment.

The performance of certain of the operations may be distributed among the processors, not only residing within a single machine 800, but deployed across a number of machines 800. In some example embodiments, the processors 810 or processor-implemented modules are located in a single geographic location (e.g., within a home environment, an office environment, or a server farm). In other example embodiments, the processors or processor-implemented modules are distributed across a number of geographic locations.

### Executable Instructions and Machine Storage Medium

The various memories (i.e., 830, 832, 834, and/or the memory of the processor(s) 810) and/or the storage unit 836 may store one or more sets of instructions 816 and data structures (e.g., software) embodying or utilized by any one or more of the methodologies or functions described herein. These instructions (e.g., the instructions 816), when executed by the processor(s) 810, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 816 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

### Transmission Medium

In some examples, one or more portions of the network 880 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 880 or a portion of the network 880 may include a wireless or cellular network, and the coupling 882 may be a Code Division Multiple Access (CDMA) connection, a Global System for Mobile communications (GSM) connection, or another type of cellular or wireless coupling. In this example, the coupling 882 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 870. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

### Computer-Readable Medium

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A system comprising:
one or more hardware processors; and
at least one machine-storage medium for storing instructions that, when executed by the one or more hardware processors, cause the one or more hardware processors to perform operations comprising:
identifying a first machine-learning (ML) model associated with an omni-view knowledge graph representing a plurality of past transaction events;
generating, using the first ML model, a first embedding vector that represents the omni-view knowledge graph;
identifying a second ML model associated with a temporal-view knowledge graph representing a plurality of ongoing transaction events;
generating, using the second ML model, a second embedding vector that represents the temporal-view knowledge graph; and
training the second ML model to learn the omni-view knowledge graph using the first embedding vector and the second embedding vector.

2. The system of claim 1, wherein the operations comprise:
applying a first loss function to the first embedding vector that represents the omni-view knowledge graph and the second embedding vector that represents the temporal-view knowledge graph; and
generating a first loss in response to applying the first loss function.

3. The system of claim 2, wherein the first loss function comprises a Normalized Temperature-scaled Cross Entropy Loss (NTXent) loss function.

4. The system of claim 2, wherein the operations comprise:
generating, using a decoder, a prediction output value of an ongoing transaction event based on the second embedding vector that represents the temporal-view knowledge graph;
applying a second loss function to the prediction output value of the ongoing transaction event; and
generating a second loss in response to applying the second loss function.

5. The system of claim 4, wherein the second loss function comprises a Binary Cross Entropy (BCE) loss function.

6. The system of claim 4, wherein the decoder comprises one of a logistic regression ML model and a multilayer neural network ML model.

7. The system of claim 4, wherein the operations comprise:
training the second ML model based on a sum value of the first loss and the second loss.

8. The system of claim 7, wherein the operations comprise:
concluding a training process of the second ML model until the sum value of the first loss and the second loss is below a threshold value.

9. The system of claim 1, wherein the first ML model comprises a Graph Neural Network (GNN) teacher ML model.

10. The system of claim 1, wherein the second ML model comprises a GNN student ML model.

11. A method comprising:
identifying, by at least one hardware processor, a first machine-learning (ML) model associated with an omni-view knowledge graph representing a plurality of past transaction events;
generating, using the first ML model, a first embedding vector that represents the omni-view knowledge graph;
identifying a second ML model associated with a temporal-view knowledge graph representing a plurality of ongoing transaction events;
generating, using the second ML model, a second embedding vector that represents the temporal-view knowledge graph; and
training the second ML model to learn the omni-view knowledge graph using the first embedding vector and the second embedding vector.

12. The method of claim 11, comprising:
applying a first loss function to the first embedding vector that represents the omni-view knowledge graph and the second embedding vector that represents the temporal-view knowledge graph; and
generating a first loss in response to applying the first loss function.

13. The method of claim 12, wherein the first loss function comprises a Normalized Temperature-scaled Cross Entropy Loss (NTXent) loss function.

14. The method of claim 12, comprising:
generating, using a decoder, a prediction output value of an ongoing transaction event based on the second embedding vector that represents the temporal-view knowledge graph;
applying a second loss function to the prediction output value of the ongoing transaction event; and
generating a second loss in response to applying the second loss function.

15. The method of claim 14, wherein the second loss function comprises a Binary Cross Entropy (BCE) loss function.

16. The method of claim 14, wherein the decoder comprises one of a logistic regression ML model and a multilayer neural network ML model.

17. The method of claim 14, comprising:
training the second ML model based on a sum value of the first loss and the second loss.

18. The method of claim 17, comprising:
concluding a training process of the second ML model until the sum value of the first loss and the second loss is below a threshold value.

19. The method of claim 11, wherein the first ML model comprises a Graph Neural Network (GNN) teacher ML model, and wherein the second ML model comprises a GNN student ML model.

20. A machine-storage medium for storing instructions that, when executed by one or more hardware processors, cause the one or more hardware processors to perform operations comprising:
identifying a first machine-learning (ML) model associated with an omni-view knowledge graph representing a plurality of past transaction events;
generating, using the first ML model, a first embedding vector that represents the omni-view knowledge graph;
identifying a second ML model associated with a temporal-view knowledge graph representing a plurality of ongoing transaction events;
generating, using the second ML model, a second embedding vector that represents the temporal-view knowledge graph; and
training the second ML model to learn the omni-view knowledge graph using the first embedding vector and the second embedding vector.
